(19) United States
(12) Patent Application Publication
(10) Pub. No.: US 2018/0359164 A1
(43) Pub. Date: Dec. 13, 2018

(54) Cloud Network Monitoring Tool

(71) Applicant: Bank of America Corporation, Charlotte, NC (US)

(72) Inventors: Yair Frankel, Westfield, NJ (US); Morgan Stewart Allen, Charlotte, NC (US); Jisoo Lee, Chesterfield, NJ (US)

(21) Appl. No.: 15/617,096

(22) Filed: Jun. 8, 2017

(51) Int. Cl. H04L 12/26; H04L 29/08

(52) U.S. Cl. CPC H04L 43/08; H04L 67/10

(57) ABSTRACT

A system includes a monitoring tool associated with a cloud service provider. The cloud service provider hosts a cloud network. The cloud network provides cloud-based services to at least a first user and a second user. The monitoring tool monitors events associated with physical components of the cloud network. The monitoring tool also determines a first subset of the physical components. The first subset includes physical components that provide one or more virtualized resources to the first user. The monitoring tool also determines a first subset of the events to communicate to the first user. The first subset of events includes events that are associated with the first subset of physical components during set up, use, and tear down of the one or more virtualized resources provided to the first user. The monitoring tool also communicates the first subset of events to the first user.

### TECHNICAL FIELD

Certain embodiments of the disclosure relate generally to monitoring events on a cloud network.

### BACKGROUND

Cloud service providers provide services to users on a cloud network. The cloud network includes a variety of physical components combined together to create a distributed cloud network. The cloud service provider may implement one or more virtual resources for a user on the cloud network using a subset of the physical components. Certain physical resources may be accessible to multiple parties. For example, a physical resource may be used by one customer for a period of time. When that customer no longer needs the physical resource, it can be allocated to another customer. Additionally, employees of the cloud service provider may continually have access to the physical resource, for example, for maintenance purposes. Thus, the convenience and flexibility offered by the cloud may have tradeoffs in terms of the customer's ability to control access to physical computing resources used by the customer.

### SUMMARY OF THE DISCLOSURE

According to an embodiment, a system includes a monitoring tool associated with a cloud service provider. The cloud service provider hosts a cloud network. The cloud network provides cloud-based services to at least a first user and a second user. The monitoring tool monitors events associated with physical components of the cloud network. The monitoring tool also determines a first subset of the physical components. The first subset includes physical components that provide one or more virtualized resources to the first user. The monitoring tool also determines a first subset of the events to communicate to the first user. The first subset of events includes events that are associated with the first subset of physical components during set up, use, and tear down of the one or more virtualized resources provided to the first user. The monitoring tool also communicates the first subset of events to the first user.

According to another embodiment, a method includes monitoring events associated with physical components of a cloud network hosted by a cloud provider. The cloud network provides cloud based services to at least a first user and a second user. The method further includes determining a first subset of the physical components. The first subset comprises the physical components that provide one or more virtualized resources to the first user. The method further includes determining a first subset of the events to communicate to the first user. The first subset of events includes events that are associated with the first subset of physical components during set up, use, and tear down of the one or more virtualized resources provided to the first user. The method further includes communicating the first subset of events to the first user.

According to yet another embodiment, a non-transitory computer-readable medium includes software. The software when executed by processing circuitry monitors events associated with physical components of the cloud network hosted by a cloud provider. The cloud network provides cloud based services to at least a first user and a second user. The software further determines a first subset of the physical components. The first subset includes physical components that provide one or more virtualized resources to the first user. The software further determines a first subset of the events to communicate to the first user. The first subset of events include events that are associated with the first subset of physical components during set up, use, and tear down of the one or more virtualized resources provided to the first user. The software further communicates the first subset of events to the first user.

Certain embodiments provide one or more technical advantages. For example, certain embodiments may allow users of cloud-based services to view events occurring outside their visibility to the virtual resources, including events occurring during the setup and tear down of the virtual resources on the physical components. These events may be used by the user to infer activity, such as attacks or unauthorized access, on their virtual resources before and after the virtual resources are live on the cloud network. As another example, certain embodiments may allow discrete event notification by obfuscating names of the physical component when the physical component is used to implement virtual resources for more than one user. In this manner, two users may both view the same event relevant to their respective virtual resources without receiving revealing information regarding the other user. As yet another example, certain embodiments may allow a user to view events on the cloud service provider's physical infrastructure, such as cloud service provider employee access and block copying of user's data on the virtual resources. In this manner, user may have increased visibility to prevent unauthorized access occurring outside the logical components of the cloud network hosting the virtual resources of the user. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates an example cloud network environment system;

FIG. 2 illustrates an example monitoring tool associated with the system of FIG. 1; and

FIG. 3 is a flowchart illustrating a method for monitoring events on a cloud network using the system of FIG. 1.

### DETAILED DESCRIPTION

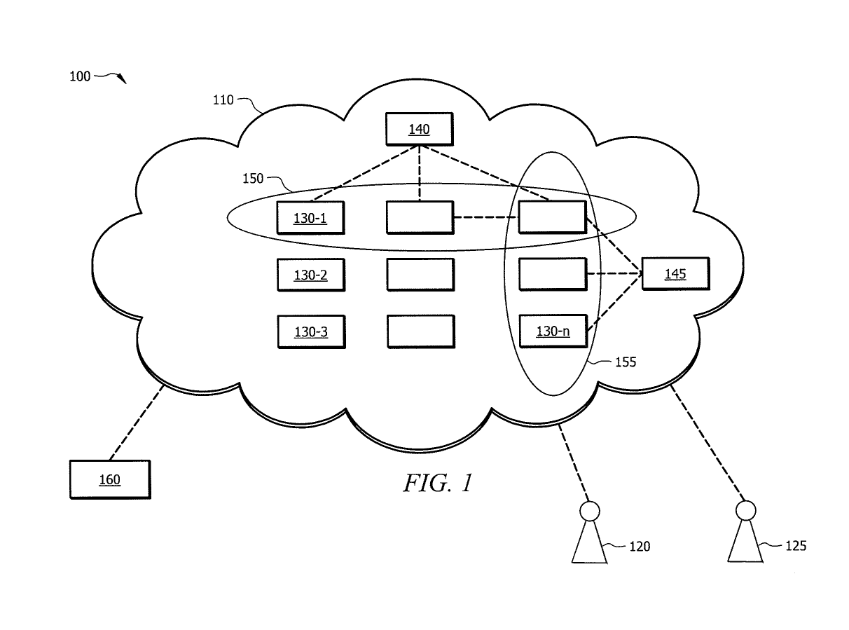

Embodiments of the present disclosure and its advantages are best understood by referring to FIGS. 1 through 3 of the drawings, like numerals being used for like and corresponding parts of the various drawings.

Generally, cloud service providers provide virtual resources on a cloud network to users. The cloud network may include a variety of physical components combined together to create a distributed cloud network. For example, the cloud network may comprise a plurality of clusters distributed geographically, each cluster comprising a plurality of physical components. The cloud service provider may allocate virtual resources using the physical components of the cloud network. Users may host data, carry out tasks, and interact with external networks using the allocated virtual resources.

The user may monitor the virtual resources once they become visible on the cloud network and accessible to the user. Conventionally, users are unable to monitor events occurring before and after the virtual resources are live on the cloud network. For example, events occurring before or during the setup of the virtual resources on the physical components are opaque to the user. Similarly, users are unable to see events occurring during or after the tear down of the virtual resources. Additionally, users are typically unable to view events occurring outside the virtual resources, such as events affecting the physical components and the cloud service provider's infrastructure. As a result, users typically receive only a very limited view of events that may affect their data, processes, and use of the resources in the cloud network. Further, the user may be unable to protect against attacks or outages that may be indicated by these non-viewable events.

Cloud service providers may implement monitors at various points in the cloud network and infrastructure to monitor and record events that occur on the network. Conventionally, few if any of the events occurring on the cloud network are communicated to the users having virtual resources implemented on the cloud network. For example, cloud service providers may not implement a centralized monitor to provide users with comprehensive information regarding the cloud network and its component parts. Furthermore, cloud service provides do not typically register physical components with the virtual resources implemented on those physical components. Accordingly, events involving the physical components may not be associated with the virtual resources. Additionally, privacy concerns may prevent a cloud provider from sharing event data to users. For example, event data may reveal information about other users sharing components of the cloud network, which may raise confidentiality concerns.

This disclosure contemplates an unconventional monitoring tool for a cloud network which widens the view of events available to users. The monitoring tool may communicate events that may impact a user's virtual resources on the cloud network while protecting sensitive information of other users and the cloud service provider. The monitoring tool may be associated with a cloud service provider and coupled to a cloud network where it receives notification of events and corresponding information. A centralized monitoring tool may receive all events that may be relevant to a user's use of the cloud network and filter those events based on a variety of criteria. Based on those criteria, the monitoring tool may ensure that users only have access to relevant events that the user desires. To enable the visibility to the users, the monitoring tool associates the relevant physical components to the virtual resources of the user. In this manner, events occurring on the physical component may be registered to the virtual resources and vice versa. In cases where physical components are used for virtual resources of multiple users, the monitoring tool may obfuscate the associated physical components to protect the privacy and security of the users.

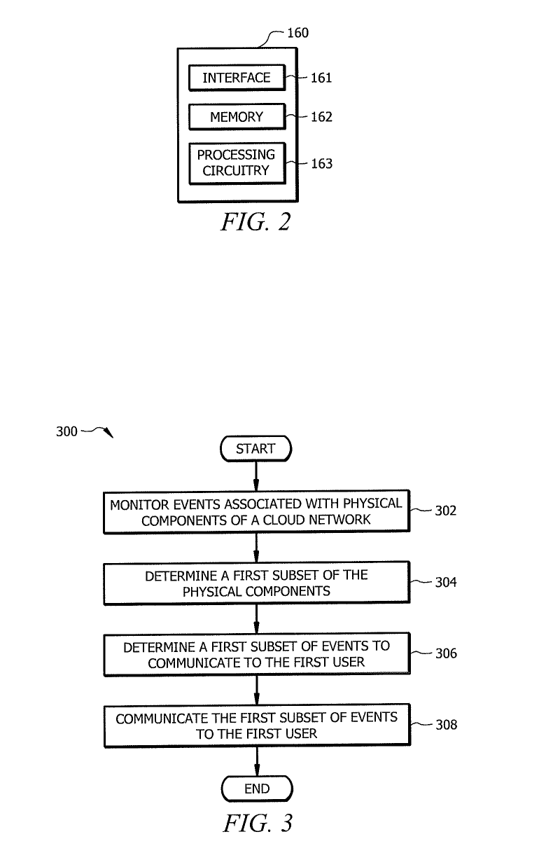

The monitoring tool will be described in more detail using FIGS. 1 through 3. FIG. 1 will describe the monitoring tool in the cloud network environment. FIG. 2 will describe the monitoring tool in more detail. FIG. 3 will describe an example method of using a monitoring tool.

FIG. 1 illustrates an example cloud system 100. Cloud system 100 may include a cloud network 110, a first user 120, a second user 125, and a monitoring tool 160. In certain embodiments, cloud system 100 provides a more visible cloud network to users 120 and 125 by communicating relevant events through monitoring tool 160 that may impact the virtual resources of the users 120 and 125.

In certain embodiments users 120 and 125 may comprise two different customers of cloud service provider. For example, first user 120 and second user 125 may comprise two entities, such as natural persons or corporations. Each of first user 120 and second user 125 may desire the ability to monitor events that may impact their use of cloud network 110 without revealing information to the other, including data and activity on cloud network 110 or even the mere fact that the user is on the same cloud network as the other.

A cloud service provider may provide cloud system 100 to provide virtual resources on cloud network 110 to first user 120 and second user 125. Cloud network 110 may comprise a plurality of physical components 130. Physical components 130 may include one or more discrete elements 130-1 through 130-N in cloud network 110. Physical components 130 may comprise one or more physical hosts, physical network components, and physical data stores. Physical components 130 may be geographically distributed. For example, some of physical components 130 may be configured in a cluster at a single location while other components of physical components 130 may be configured into another cluster at another location. The clusters may be coupled over networks or other interfaces to provide the physical infrastructure for a distributed cloud network 110. Alternatively, in certain embodiments, cloud network 110 comprises physical components 130 located at a single location.

Physical components 130 may be used to implement virtual resources 140 and 145. Virtual resources 140 and 145 may comprise a virtual container or a virtual machine. For example, virtual resources 140 may comprise a virtual container in which first user 120 hosts secure data outside of an internal network or personal devices. As another example, virtual resources 140 may be used to implement a virtual machine on which first user 120 runs tasks that require excess processing capability.

In certain embodiments, virtual resources 140 and 145 may be implemented for first user 120 and second user 125, respectively. First user 120 and second user 125 may host data, carry out tasks, and/or interface with external networks using virtual resources 140 and 145. Users 120 and 125 may communicate with cloud network 110 to utilize their respective virtual resources 140 and 145 through any suitable interface and/or network. For example, first user 120 may use its own servers and/or networks to communicate with cloud network 110. Data may be shared between the cloud service provider and first user 120 through cloud network 110 or an external network.

In certain embodiments, virtual resources 140 may be implemented using the physical components of first subset 150. Likewise, virtual resources 145 may be implemented using the physical components of second subset 155. As illustrated in FIG. 1, in certain embodiments, one or more of the physical components of first subset 150 may also be found in second subset 155. In this manner, cloud network 110 may maximize the amount of virtual resources implemented on physical components 130 by sharing particular physical components across users in some instances.

In certain embodiments, first user 120 may monitor the activity of virtual resource 140. For example, first user 120 may receive information from the cloud service provider or implement its own monitoring system to monitor events occurring within the established virtual resources 140. As discussed above, conventionally, first user 120 is limited in viewing events outside the established virtual resources 140, including events occurring during the establishment and disassociation of virtual resources 140 on cloud network 110 and events occurring outside virtual resources 140, such as events affecting physical components 130 and/or the physical infrastructure of cloud network 110.

Cloud system 100 may use monitoring tool 160 to supplement the information provided to users 120 and 125 regarding events that may impact each of users' virtual resources 140 and 145. In certain embodiments, monitoring tool 160 may be a separate system from cloud network 110. In other embodiments, monitoring tool 160 may be implemented on cloud network 110. For example, portions of or all of monitoring tool 160 may be implemented on one or more of physical components 130-1 through 130-N or on other components of cloud network 110, such as components of cloud network 110′s physical infrastructure. In certain embodiments, monitoring tool 160 is distributed across multiple systems.

In certain embodiments, monitoring tool 160 communicates with other monitoring systems, tools, or apparatuses, of cloud network 110 to receive information about activity on cloud network 110. For example, each cluster in cloud network 110 may include its own monitoring tool which may communicate with monitoring tool 160. As another example, cloud network 110′s physical infrastructure may include monitoring systems that monitor activity including the activity of the cloud service provider's employees or other higher level activity on cloud network 110. Events detected through cloud network 110 may be communicated to monitoring tool 160. In certain embodiments, monitoring tool 160 may directly monitor events at one or more components of cloud network 110.

Monitoring tool 160 may carry out a variety of functions to provide the enhanced visibility of activity on cloud network 110 to users 120 and 125. As discussed above, monitoring tool 160 may be coupled to portions of cloud network 110 and cloud system 100 in order to for monitoring tool 160 to monitor events on cloud network 110 and cloud system 100. In certain embodiments, monitoring tool 160 monitors events associate with physical components 130 of cloud network 110. For example, monitoring tool 160 may monitor each physical component 130 individually or receive events from a cluster-level monitoring system. The events being monitored by monitoring tool 160 may include any event that may occur on one or more of physical components 130. For example, events may comprise one or more of an access, read/write, or use of the individual physical component 130.

In certain embodiments, monitoring tool 160 may determine first subset 150 of physical components 130 associated with first user 125. First user 125 may be provided one or more virtual resources 140 on cloud network 110. To provide relevant events to first user 125, monitoring tool 160 may first determine which physical components of physical components 130 are associated with first user 125. For example, monitoring tool 160 may determine first subset 125 that is providing one or more virtualized resources 140 to first user 125. In this manner, monitoring tool 160 may be able to associate events on the physical level to the virtual level of the user. Similarly, monitoring tool 160 will also be able to associate events on the virtual level to the physical level. As a result, monitoring tool 160 may provide a comprehensive monitoring of cloud network 110.

Monitoring tool 160 may monitor the entire cloud network 160 or alternatively, some portion thereof. In certain embodiments, monitoring tool 160 may monitor physical components 130 that are used to provide virtual resources to more than one user. For example, the illustrated embodiment depicted in FIG. 1 shows monitoring tool 160 monitoring events on cloud network 110, which provides virtualized resources 140 and 145 to two users, first user 120 and second user 125. In particular embodiments, monitoring tool 160 may only communicate events to users 120 and 125 that are relevant to the particular user.

In certain embodiments, monitoring tool may determine a first subset of the monitored events to communicate to first user 120. For example, the first subset of events may comprise events only related to virtualized resources 140 and the physical components 130 on which virtualized resources 140 are provided. In some embodiments, the first subset of events includes events that are associated with first subset 150 of physical components 130. In this manner, only events associated with the resources provided to first user 120 are communicated to first user 120.

In certain embodiments, the first subset of events includes events associated with first subset 150 of physical components 130 during set up, use, and tear down of one or more virtualized resources 140 provided to first user 120. For example, the first subset of events may include events before virtualize resources 140 are available to user 120 and after access to virtualized resources 140 is removed. These periods may represent vulnerable times where unauthorized entry may occur with lessened security and limited monitoring. First user 120 may use events during these time periods to ascertain any unauthorized access and remedy any breach in its data or activities on cloud network 110.

The set up and tear down periods may be determined in various ways. In some embodiments, set up and tear down may be determined based on analyzing messaging in cloud network 110 and cloud system 100. For example, set up may be started upon the receipt of a message requesting the set up of a virtualized resource and tear down may end upon receipt of a message indicating the virtual resources have been wiped and released for subsequent use. In some embodiments, set up may refer to a predetermined time period prior to use of the virtualized resources and tear down may refer to a predetermined time period after the end of use of the virtualized resources. For example, monitoring tool 160 may include events occurring a set time period before and after the virtualized resources become live on cloud network.

Once monitoring tool 160 determines the first subset of events, monitoring tool 160 may communicate those events to first user 120. In certain embodiments, monitoring tool 160 may communicate the first subset of events on a continuous basis, such as in real-time as the events occur. In some embodiments, the first subset of events are only communicated upon request by first user 120. In certain embodiments, the first subset of events may be communicated to first user 120 according to a predetermined rule. For example, communication of events may occur according to a predetermined schedule, such as a summary report every hour and a detailed report once daily at midnight. The communication of events by monitoring tool 160 may be controlled by the cloud service provider and/or users 120 and 125. For example, cloud service provider may limit the number of times events are communicated during a period of time. Similarly, users 120 and 125 may have a preference for when and how often events should be communicated.

In certain embodiments, the communication of events may depend on the type of event. For example, certain events may be designated by a priority or a type. Certain priorities or types of events may be subject to immediate communication. Additionally, users 120 and 125 may classify types events and indicate the preferred communication of those events based on those types. By allowing flexibility in communicating events to users 120 and 125, monitoring tool 160 may ensure that users 120 and 125 receive event information in a timely manner so that users 120 and 125 may respond to any threat or breach, thereby limiting any damage done to their resources in cloud network 110.

In certain embodiments, communicating the first subset of events to first user 120 includes authenticating a request from first user 120 before communication of the first subset of events. For example, first user 120 may provide a security identification or authentication key to monitoring tool 160. In response to a valid authentication, monitoring tool 160 may communicate the events to first user 120. In this manner, events are only communicated to authorized users and only to the particular user associated with the virtualized resources and underlying physical components subject to the monitored events communicated. In certain embodiments, the events are communicated via an authenticated push or pull method.

In certain embodiments, monitoring tool 160 may filter the first subset of events based on criteria from first user 120. For example, monitoring tool 160 may receive criteria including event categorization, prioritization information, and attack signatures from first user 120. Monitoring tool 160 may then use these criteria to filter the first subset of events. Accordingly, first user 120 may only receive events according to its provided criteria. Similarly, in certain embodiments, the cloud service provider may also filter the first subset of events based on its own criteria. For example, cloud service provider may want to filter out events that could be used to compromise the security of cloud network 110. In certain embodiments, the first subset of events excludes events not associated with first subset 150 of physical components 130 during set up, use, and tear down of one or more virtualized resources 140 provide to first user 120. For example, monitoring tool 160 may filter any events not directly related to the provision of virtualized resources 140. In this manner, only specific events may be communicated to first user 120, eliminating unnecessary communication of irrelevant events to the user 120.

In certain embodiments, when determining the first subset of events, monitoring tool 160 may further filter our one or more event types not associated with first user 120. As discussed above, one or more event types may be associated, or conversely not associated, with first user 120 based on first user 120′s own communicated criteria. For example, first user 120 may provide the cloud service provider with information to include or exclude particular event types. Additionally, the cloud service provider may exclude certain event types by requesting monitoring tool 160 to filter those events. For example the cloud service provider may want to prevent confidential information being communicated to first user 120 or may filter out events completely irrelevant to virtualized resource 140 even if it is relevant to the underlying physical components used to provide virtualized resource 140.

In certain embodiments, monitoring tool 160 may communicate an indication of the physical component of physical components 130 associated with a particular event and an indication of virtualized resource 140 associated with the particular event. For example, monitoring tool 160 may communicate these indications with each event communicated to first user 120. First user 120 may then use these indications to track various activities across virtualized resources 140 and physical components 130. For example, certain patterns of attacks may be recognizable only from the perspective of the physical component. If no indication is provided in communicating the events, first user 120 may not be able to utilize the information to prevent attacks on its resources or determine if there has been unauthorized access to its systems on cloud network 110. By providing the correlation between virtualized resources 140 and physical components 130, first user 120 may more efficiently recognize event patterns and better secure its data and resources on cloud network 110.

In certain embodiments, the indication of the physical component includes an obfuscated name of the physical component. For example, the cloud provider may desire to protect certain information regarding the physical component, including information regarding capability, security, and location in cloud network 110. By obfuscating the name of the physical component, monitoring tool 160 may still allow the indication of the physical component to be used by first user 120 while still protecting the sensitive information of the physical component.

In certain embodiments, monitoring tool 160 may communicate events to multiple users. For example, monitoring tool 160 may communicate events to first user 120 and second user 125. Monitoring tool 160 may determine second subset 155 of physical components 130 that provide one or more virtualized resources 145 to second user 125. Then, monitoring tool 160 may determine a second subset of events to communicate to second user 125. The second subset of events may include events associated with second subset 155 during set up, use, and tear down of the one or more virtualized resources 145. The second subset of events may then be communicated to second user 125. In this manner, second user 125 may also receive event information that enhances the visibility into activities on cloud network 110 while protecting sensitive information of cloud network 110.

In certain embodiments, a physical component of physical components 130 may be shared between first user 120 and second user 125. In some embodiments, first user 120 and second user 125 may have their virtualized resources implemented on the same cluster or on the same subset of physical components 130. For example, in the illustrated embodiment, first subset 150 overlaps with second subset 155 over at least one of physical components. In this case, providing either user with the physical component name may divulge the proximity of the other user on cloud network 110 and the indication that one or more physical components 130 are shared with another user. Based on the patterns of events, a user may be able to derive that a particular physical component is shared with another user, which may be used to compromise the security of the other user. In certain embodiments, each user may receive a different obfuscated name for the shared physical component. In this manner, information that the physical component is shared amongst multiple users is protected while still providing the important event information to the users.

While first user 120 and second user 125 are disclosed as users on cloud network 110, any number of users may have virtualized resources implemented on physical components 110 of cloud network 110. As described above, physical components may be shared between users and monitoring tool 160 may communicate the events associated with the user's use of cloud network while still protecting sensitive information about cloud network 110 and other users.

In certain embodiments, the first subset of events may include events associated with other portions of cloud system 100. In some embodiments, the first subset of events includes events associated with the physical infrastructure of cloud network 110. For example, cloud network 110 may include infrastructure through which the cloud service provider may access elements of cloud network 110. The cloud service provider may access various parts of cloud network 110 for maintenance, security purposes, or setting up or tearing down virtual resources. The physical infrastructure may implemented outside of physical components 130 of cloud network 110. In these cases, events relating to virtualized resources 140 may not be monitored and communicated to first user 120 even if they may have an impact on its use of cloud network 110.

In certain embodiments, monitoring tool 160 may monitor the physical infrastructure for events relating to first user 120 and second user 125. For example, monitoring tool 160 may monitor the cloud service provider access of one or more virtualized resources 140 of first user 120 and include those events in the first subset of events communicated to first user 120. As a result, attacks or unauthorized access from the cloud service provider side may also be detected and protected against. As one example, block copying of first user 120′s data stored in a virtual container on cloud network 110 may be included as an event in the first subset of events communicated to first user 120. This may indicate that a particular employee's credentials have been compromised or that the cloud service provider has been compromised. In response, first user 120 may alert the cloud service provider or take affirmative action to lock down its data on cloud network 110, thereby reducing any losses of data or unauthorized access of its systems.

Certain embodiments disclosed herein may provide one or more technical advantages. For example, certain embodiments may allow users of cloud-based services to view events occurring outside their visibility to the virtual resources, including events occurring during the setup and tear down of the virtual resources on the physical components. These events may be used by the user to infer activity, such as attacks or unauthorized access, on their virtual resources before and after the virtual resources are live on the cloud network. As another example, certain embodiments may allow discrete event notification by obfuscating names of the physical component when the physical component is used to implement virtual resources for more than one user In this manner, two users may both view the same event relevant to their respective virtual resources without receiving revealing information regarding the other user. As yet another example, certain embodiments may allow a user to view events on the cloud service provider's physical infrastructure, such as cloud service provider employee access and block copying of user's data on the virtual resources. In this manner, user may have increased visibility to prevent unauthorized access occurring outside the logical components of the cloud network hosting the virtual resources of the user. Certain embodiments may include none, some, or all of the above technical advantages. One or more other technical advantages may be readily apparent to one skilled in the art from the figures, descriptions, and claims included herein.

FIG. 2 illustrates further details of monitoring tool 160 associated with cloud system 100 of FIG. 1. Monitoring tool 160 includes an interface 161, memory 162, and processing circuitry 163. Memory 162 may store instructions that, when run by processing circuitry 163, may cause processing circuitry 163 of monitoring tool 160 to perform any of the operations of monitoring tool 160 described in the disclosure. In certain embodiments, monitoring tool 160 may supplement the events visible to users 120 and 125 and enhance security on a cloud network without compromising privacy or sensitive data.

Processing circuitry 163 is any electronic circuitry, including, but not limited to microprocessors, application specific integrated circuits (ASIC), application specific instruction set processor (ASIP), and/or state machines, that communicatively couples to memory 130 and controls the operation of monitoring tool 160. Processing circuitry 163 may comprise one or more processors that are 8-bit, 16-bit, 32-bit, 64-bit or of any other suitable architecture. Processing circuitry 163 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. Processing circuitry 163 may include other hardware and software that operates to control and process information. Processing circuitry 163 executes software stored on memory to perform any of the functions described herein. Processing circuitry 163 controls the operation and administration of monitoring tool 160 by processing information received from cloud network 110, users 120 and 125, and memory 162. Processing circuitry 163 may be a programmable logic device, a microcontroller, a microprocessor, any suitable processing device, or any suitable combination of the preceding. Processing circuitry 163 is not limited to a single processing device and may encompass multiple processing devices.

Memory 162 may store, either permanently or temporarily, data, operational software, or other information for processing circuitry 163. Memory 162 may include any one or a combination of volatile or non-volatile local or remote devices suitable for storing information. For example, memory 162 may include random access memory (RAM), read only memory (ROM), magnetic storage devices, optical storage devices, or any other suitable information storage device or a combination of these devices. The software represents any suitable set of instructions, logic, or code embodied in a computer-readable storage medium, including a non-transitory computer-readable medium. For example, the software may be embodied in memory 162, a disk, a CD, or a flash drive. In particular embodiments, the software may include an application executable by processing circuitry 163 to perform one or more of the functions described herein.

Interface 161 may be any suitable interface to transmit data comprising events occurring on cloud network 110 to monitoring tool 160. In certain embodiments, interface 161 includes one or more transceivers capable of communicating with cloud network 110 and to users 120 and 125. For example, interface 161 of monitoring tool 160 may include a communication interface configured to communicate one or more events, such as in an event log, to first user 120 and second user 125 according to various embodiments disclosed herein. Monitoring tool 160 may comprise any additional elements necessary to incorporate monitoring tool 160 into cloud system 100 and perform the functions as described in particular embodiments herein.

FIG. 3 is a flowchart illustrating a method 300 for monitoring events on cloud network 110 of cloud system 100 of FIG. 1. In particular embodiments, monitoring tool 160 performs method 300. By performing method 300, monitoring tool 160 enhances the visibility on cloud network 110 to users 120 and 125 by communicating relevant events associated with the physical components of cloud network 110.

Method 300 may begin with step 302. At step 302, events associated with physical components of a cloud network may be monitored. For example, monitoring tool 160 may monitor events associated with physical components 130 of cloud network 110.

In step 304, a first subset of the physical components of the cloud network are determined. In certain embodiments, the first subset may include the physical components that provide one or more virtualized resources to a first user. For example, first subset 150 may include physical components of physical components 130 that are used to provide virtualized resources 140 to first user 120. In this manner, method 300 may target only relevant components of the cloud network to report to a particular user.

In step 306, a first subset of the events are determined to communicate to the first user. In certain embodiments, the first subset of events are associated with the determined first subset of physical components during set up, use, and tear down of the one or more virtualized resources provided to the first user. For example, the first subset of the events may include events during the set up, use, and tear down of virtualized resources 140 of first user 120 limited to events related to first subset 150 of physical components 130.

In step 308, the first subset of events are communicated to the first user. For example, the first subset of events are communicated to first user 120 by monitoring tool 160. In this manner, method 300 may provide the first user with events associated with its virtualized resources, including events associated with the underlying

In particular embodiments, method 300 may comprise additional steps. For example, in certain embodiments, method 300 further includes determining a second subset of the physical components, determining a second subset of the events to communicate to a second user, and communicating the second subset of events to the second user. In certain embodiments, the second subset of the physical components comprises physical components that provide one or more virtualized resources to the second user. In some embodiments, the second subset of events include events associated with the second subset of physical components during set up, use, and tear down of the one or more virtualized resources provided to the second user. In this manner, events may be communicated to a second user in addition to a first user.

In some embodiments, the events communicated to the first user and the second user may overlap, or the first subset of physical components and the second subset of physical components may include one or more common physical components. In certain embodiments, the method may prevent the users from knowing they may share a physical component with another user by obfuscating the name of the physical component in the events communicated to each user.

Modifications, additions or omissions may be made to method 300 depicted in FIG. 3. Method 300 may include more, fewer, or other steps. For example, steps may be performed in parallel or any suitable order. While discussed as fraud remedy tool 120 performing the steps, any suitable component of system 100, such as devices 110 for example, may perform one or more of the steps of the method.

Although the present disclosure includes several embodiments, a myriad of changes, variations, alterations, transformations and modifications may be suggested to one skilled in the art and it is intended that the present disclosure encompass such changes, variations, alterations, transformations and modifications as fall within the scope of the appended claims.

What is claimed is:

1. A system, comprising:
a monitoring tool associated with a cloud service provider, wherein the cloud service provider hosts a cloud network operable to provide cloud-based services to at least a first user and a second user, and wherein the monitoring tool comprises a memory storing instructions and processing circuitry that, when running the instructions, is caused to:
monitor events associated with physical components of the cloud network;
determine a first subset of the physical components, wherein the first subset comprises physical components that provide one or more virtualized resources to the first user;
determine a first subset of the events to communicate to the first user, wherein the first subset of events includes events that are associated with the first subset of physical components during set up, use, and tear down of the one or more virtualized resources provided to the first user; and
communicate the first subset of events to the first user.

2. The system of claim 1, wherein the first subset of events excludes events that are not associated with the first subset of physical components during set up, use, and tear down of the one or more virtualized resources provided to the first user.

3. The system of claim 1, wherein determining the first subset of the events further comprises filtering out one or more event types not associated with the first user.

4. The system of claim 1, wherein each event communicated in the first subset of events comprises an indication of a physical component in the first subset of physical components associated with that event and an indication of the virtualized resource associated with that event.

5. The system of claim 4, wherein the indication of the physical component comprises an obfuscated name of the physical component.

6. The system of claim 5, wherein the processing circuitry is further caused to:
determine a second subset of the physical components, wherein the second subset comprises physical components that provide one or more virtualized resources to the second user;
determine a second subset of events to communicate to the second user, wherein the second subset of events include events that are associated with the second subset of physical components during set up, use, and tear down of the one or more virtualized resources provided to the second user; and
communicate the second subset of events to the second user;
wherein at least one of the physical components in the second subset is the same as at least one of the physical components in the first subset and that same physical component is referred to by a different obfuscated name in the communication to the second user.

7. The monitoring tool of claim 1, wherein the first subset of the events further includes events associated with the physical infrastructure of the cloud network comprising cloud service provider access of the one or more virtualized resources provided to the first user.

8. A method, comprising:
monitoring events associated with physical components of a cloud network hosted by a cloud provider, wherein the cloud network is operable to provide cloud based services to at least a first user and a second user;
determining a first subset of the physical components, wherein the first subset comprises physical components that provide one or more virtualized resources to the first user;
determining a first subset of the events to communicate to the first user, wherein the first subset of events includes events associated with the first subset of physical components during set up, use, and tear down of the one or more virtualized resources provided to the first user; and
communicating the first subset of events to the first user.

9. The method of claim 8, wherein the first subset of events excludes events that are not associated with the first subset of physical components during set up, use, and tear down of the one or more virtualized resources provided to the first user.

10. The method of claim 8, wherein determining the first subset of the events further comprises filtering out one or more event types not associated with the first user.

11. The method of claim 8, wherein each event communicated in the first subset of events comprises an indication of a physical component in the first subset of physical components associated with that event and an indication of the virtualized resource associated with that event.

12. The method of claim 11, wherein the indication of the physical component comprises an obfuscated name of the physical component.

13. The method of claim 12, further comprising:
determining a second subset of the physical components, wherein the second subset comprises physical components that provide one or more virtualized resources to the second user;
determining a second subset of events to communicate to the second user, wherein the second subset of events include events that are associated with the second subset of physical components during set up, use, and tear down of the one or more virtualized resources provided to the second user; and
communicating the second subset of events to the second user;
wherein at least one of the physical components in the second subset is the same as at least one of the physical components in the first subset and that same physical component is referred to by a different obfuscated name in the communication to the second user.

14. The method of claim 8, wherein the first subset of the events further includes events associated with the physical infrastructure of the cloud network comprising cloud service provider access of the one or more virtualized resources provided to the first user.

15. A non-transitory computer-readable medium comprising software, the software when executed by one or more processors operable to:
monitor events associated with physical components of the cloud network hosted by a cloud provider, wherein the cloud network is operable to provide cloud based services to at least a first user and a second user;
determine a first subset of the physical components, wherein the first subset comprises physical components that provide one or more virtualized resources to the first user;
determine a first subset of the events to communicate to the first user, wherein the first subset of events include events that are associated with the first subset of physical components during set up, use, and tear down of the one or more virtualized resources provided to the first user; and
communicate the first subset of events to the first user.

16. The medium of claim 15, wherein the first subset of events excludes events that are not associated with the first subset of physical components during set up, use, and tear down of the one or more virtualized resources provided to the first user.

17. The medium of claim 15, wherein the software when executed by one or more processors to determine the first subset of the events is further operable to filter out one or more event types not associated with the first user.

18. The medium of claim 15, wherein each event communicated in the first subset of events comprises an indication of a physical component in the first subset of physical components associated with that event and an indication of the virtualized resource associated with that event.

19. The medium of claim 18, wherein the indication of the physical component comprises an obfuscated name of the physical component.

20. The medium of claim 19, wherein the software when executed by one or more processors is further operable to:
determine a second subset of the physical components, wherein the second subset comprises physical components that provide one or more virtualized resources to the second user;
determine a second subset of events to communicate to the second user, wherein the second subset of events include events that are associated with the second subset of physical components during set up, use, and tear down of the one or more virtualized resources provided to the second user; and
communicate the second subset of events to the second user;
wherein at least one of the physical components in the second subset is the same as at least one of the physical components in the first subset and that same physical component is referred to by a different obfuscated name in the communication to the second user.
